(19) United States
(12) Patent Application Publication
(10) Pub. No.: US 2025/0215229 A1
(43) Pub. Date: Jul. 3, 2025

(54) ROOFING MATERIAL AND METHODS FOR MAKING THE SAME

(71) Applicant: HONEYWELL INTERNATIONAL INC., Charlotte, NC (US)

(72) Inventors: Yonghong RUAN, Wayne, NJ (US); Scott M. HACKER, River Edge, NJ (US); Rakesh VIG, Durham, CT (US)

(73) Assignee: HONEYWELL INTERNATIONAL INC., Charlotte, NC (US)

(21) Appl. No.: 18/935,819

(22) Filed: Nov. 4, 2024

Related U.S. Application Data
(60) Provisional application No. 63/603,722, filed on Nov. 29, 2023.

(51) Int. Cl. C08L 95/00

(52) U.S. Cl. CPC C08L 95/00; C08L 2205/025; C08L 2205/03; C08L 2205/16; C08L 2207/22; C08L 2207/24; C08L 2555/86

(57) ABSTRACT

A roofing bitumen composition includes a paving grade bitumen feedstock, a low MW polyolefin, and 9-60% of a material selected from the group of kraft lignin, recycled fibrous material, recovered bitumen from recycled asphalt shingles (RAS), reclaimed asphalt pavement (RAP), recycled tire rubber (RTR), and combinations thereof. This roofing bitumen composition has a calculated reduction in scope 3 carbon footprint between about 5% and 60%.

### TECHNICAL FIELD

The technical field relates generally to bitumen compositions and methods for making bitumen compositions. More particularly, the technical field relates to bitumen compositions for roofing applications and methods for making the same.

### BACKGROUND

Bitumen is commonly collected or synthesized and refined for use in paving and roofing applications. The type of bitumen suitable for paving applications is commonly referred to as “paving grade bitumen,” or “paving bitumen.” Typically, it will have a penetration grade that ranges from 15 to 450 for road bitumen, where one penetration unit equals 0.1 mm of penetration in accordance with ASTM D 946. The most used range for paving bitumen is 25 to 200. Bitumen suitable for roofing applications is commonly referred to as “roofing flux,” “flux bitumen,” or simply “flux.” About 90% of bitumen is road grade, while roofing bitumen represents about 10%. In general, paving bitumen is harder than roofing flux. In fact, roofing flux is initially too soft to be used, especially for roofing shingle manufacturing.

A process called “air blow,” or “oxidation,” is applied to roofing flux to make it harder and, therefore, more suitable for roofing applications. The product of such air blow processes is called “blown coating” or “oxidized asphalt” including material from blowstill and revovered from RAP and RAS or “oxidized bitumen” and is suitable for use to make roofing products, such as roofing shingles. In the “air blow” process, roofing grade bitumen is brought up to over 500 degrees F. (260 degrees C.) for 5-8 hours. Heated air is blown through the heated roofing grade bitumen to oxidize the material to form oxidized bitumen. This process by its nature produces large amounts of greenhouse gases and other distillate off gasses. The large amounts of greenhouse gases are created from the off-gased material as well as the energy needed to maintain the elevated temperature of the material.

For roofing applications, oxidized bitumen may be applied directly to a roof structure, and aggregate spread over and pressed into the bitumen to form a built-up roofing membrane or sheet. Alternatively, flux bitumen or oxidized bitumen may be coated onto fiberglass, polyester or other sheet-like material to form a membrane or shingle. Inorganic filler such as mineral filler may also be mixed into the flux bitumen or oxidized bitumen for roofing applications. Additional components such as recycled material, performance additives, or combinations thereof, may be added to the bitumen.

High-temperature performance additives, e.g., plastomers and/or elastomers, and/or low temperature performance additives, e.g., process oils, may be incorporated into the bitumen materials to vary the material properties thereof. The high temperature performance additives tend to increase the modulus of the bitumen material at higher temperatures to resist permanent deformation and creep, while the low temperature performance additives tend to increase flexibility and ductility of the bitumen material at lower temperatures to resist brittleness and cracking. While the roofing industry continues its efforts to develop a balance between physical properties and environmental factors, the emission of greenhouse gases and energy consumption during the manufacturing of roof products continues to be a challenge for the roofing industry.

Accordingly, it is desirable to provide bitumen compositions for producing roofing products with reduced carbon footprint that maintain acceptable material properties. It also is desirable to provide methods for making such bitumen compositions. In addition, it is desirable to provide a method and composition for forming roofing bitumen products using less expensive, more readily available paving grade bitumen. Additional beneficial features and characteristics of the bitumen compositions will become apparent from the subsequent detailed description and examples.

### SUMMARY

A roofing bitumen composition is formed from pavement-grade bitumen. The roofing bitumen composition includes a paving grade bitumen feedstock, alow molecular weight synthetic polyolefin, and 9-60% of a material selected from the group of kraft lignin, recycled fibrous material, recovered bitumen from waste roofing shingles, ground waste tire rubber, and combinations thereof. This roofing bitumen composition reduces the carbon footprint from traditional bitumen roofing materials and has superior properties. The carbon footprint, as determined by reduction in greenhouse gases generated through the production of the roofing bitumen composition, is calculated between about 5% and 60%, as compared to conventional roofing bitumen compositions, depending on the roofing bitumen compositions and methods of manufacture disclosed herein.

Another exemplary embodiment provides a roofing bitumen composition as described above that has a softening point of 88° C. to 160° C. and a penetration at 25° C. of minimum 15 dmm and is further composed of from about 80% to about 95% by weight paving grade bitumen feedstock, 5% to 20% ground waste tire rubber 1-5% by weight oxidized high-density polyethylene homopolymer, alkylene maleic anhydride, or combinations thereof, wherein all amounts are based on the total weight of the roofing bitumen composition.

Another exemplary embodiment provides a roofing bitumen composition as described above that has a softening point of 88° C. to 160° C. and a penetration at 25° C. of minimum 15 dmm and is further composed of from about 70% to about 95% by weight paving grade bitumen feedstock, 5% to 30% kraft lignin, 1-5% by weight oxidized high-density polyethylene homopolymer, alkylene maleic anhydride, or combinations thereof, wherein all amounts are based on the total weight of the roofing bitumen composition.

Another exemplary embodiment provides a roofing bitumen composition as described above that has a softening point of 88° C. to 160° C. and a penetration at 25° C. of minimum 15 dmm and is further composed of from about 30% to about 60% by weight paving grade bitumen feedstock, 30% to 60% by weight bitumen retrieved from recycled asphalt shingle (RAS) or reclaimed asphalt pavement (RAP), 1-5% by weight oxidized high-density polyethylene homopolymer, alkylene maleic anhydride, polyethylene homopolymer, Fisher-Tropsch wax, or combinations thereof, wherein all amounts are based on the total weight of the roofing bitumen composition.

In accordance with still another exemplary embodiment, a method for making a roofing bitumen composition for use in roofing applications is provided. The roofing bitumen composition is made by a method including mixing a paving grade bitumen feedstock 10% to 95% by weight, a polyolefin 1% to 20% by weight, and a carbon footprint reducing material 5% to 60% by weight selected from the group of kraft lignin, recycled fibrous material, recovered bitumen from waste roofing shingle or reclaimed asphalt pavement (RAP), ground waste tire rubber, and combinations thereof, wherein all amounts are based on the total weight of the roofing bitumen composition. The material can be prepared by mixing the materials at an elevated temperature using a low shear mixer speed. This method results in a roofing bitumen composition with a decreased carbon footprint as compared to an oxidized bitumen from oxidized roof-grade bitumen with a reduction of greenhouse gas emissions of 5-60%.

### DETAILED DESCRIPTION

The following description is merely exemplary and is not intended to limit the invention or the application and uses of the invention. Furthermore, there is no intention to be bound by any theory presented in the preceding background round or the following description.

The various embodiments contemplated herein relate to roofing grade bitumen compositions having significantly reduced carbon footprint compared to previous roofing grade bitumen compositions. In this regard, the manufacture of the bitumen compositions described herein can be produced with significantly less energy when compared to roofing grade bitumen using the “air blow” process, where roofing grade bitumen is brought up to over 500 degrees F. for 5-8 hours and oxidized to gain desired material properties. Due to the lower energy requirements for producing the bitumen compositions, the bitumen compositions are considered to have a reduced carbon footprint as compared to conventional bitumen compositions.

The various embodiments contemplated can be used to form roofing products that include, without limitation, roofing shingles, roofing membranes (also known as roll roofing) and waterproof membranes for various construction applications (tunnel, commercial & residential building, etc.). In an exemplary embodiment, the bitumen composition comprises pavement-grade bitumen that may include oxidized bitumen. It is notable that the presence of polyolefin, for example low molecular weight polyolefin, or oxidized polyethylene homopolymer in the bitumen composition increases and improves the heat resistance properties but does not generally interfere with other important properties of the roofing products in a negative manner, such as cold bending, softening point, penetration, and viscosity, even when the bitumen composition contains other components such as inorganic filler, recycled material, performance additives, or combinations thereof. The bitumen composition also comprises a carbon footprint reduction material selected from the group of kraft lignin, fibrous material, recovered bitumen from waste roofing shingle, ground waste tire rubber, and combinations thereof. Other well-known additives such as oils, plasticizers, antioxidants, and the like may also be included. A method of producing the bitumen compositions is also provided.

Without wishing to be bound by theory, it is believed that the release of greenhouse gases during the production of bitumen roofing products occurs mainly during “air blow,” or “oxidation,” process in the production of the bitumen roofing product. Although this process increases the material properties that are required for roofing uses, the manufacturing processes result in the increase of energy needed for production as well as gaseous emissions during the manufacturing process. These emissions and energy use issues must be managed. In addition to the environmental issues related to manufacturing, the large amount of emissions and energy diminishes roofing manufacturers' profitability.

The characteristic of a roofing bitumen composition is set by industrial standard tests. These tests for characterizing the properties of roofing bitumen compositions include: Penetration (D 5, Test Method for Penetration of Bituminous Materials), Softening Point (D 36, Test Method for Softening Point of Bitumen), Flash and Fire Points (D 92, Test Method for Ductility of Bituminous Materials), and Solubility (D 2402, Test Method for Solubility of Asphalt Materials in Trichloroethylene). Additionally, roofing bitumen composition characterization includes tests for weathering, ASTM D 4798, Standard Practice for Accelerated Weathering Test Conditions and Procedures for Bituminous Materials.

Similarly, as will be familiar and understood to persons of ordinary skill in the art, other characteristics of bitumen compositions intended for use in bitumen roofing products are important, quantified and monitored. For example, the cold bending temperature is the minimum temperature at which a bitumen composition sample will not break or fracture under bending. For bitumen compositions to be useful for roofing applications, acceptable cold bending temperatures are about −20° C. (−4° F.) or lower for SBS modified bitumen roofing membrane, and −5° C. (23° F.) or lower for atactic polypropylene (APP) modified bitumen roofing membrane. For roofing shingles in the US, acceptable cold bending temperatures are about 25° C. (77° F.).

Also, bitumen compositions do not have distinct melting points but rather a range of temperatures within which the materials begin and continue to soften without melting. It is beneficial to know the temperature ranges in which bitumen compositions will become too soft to be used in construction and manufacturing and, therefore, the softening point of an bitumen composition is an important characteristic to be measured. Bitumen compositions suitable for use in roofing applications and products should have a softening point of about 87.8 to about 160° C. (about 190 to about 320° F.)

The penetration test provides a measure of the consistency of a bitumen feedstock at a given temperature. The consistency is a function of the types of chemical constituents of the bitumen and their relative amounts in the bitumen, which are determined by the source petroleum and the method of processing at the refinery. The penetration is measured using a standard needle which is brought to the surface of the bitumen specimen, at right angles, and allowed to penetrate the bitumen for a period such as 5 seconds, while the temperature of the specimen is maintained at certain value such as 25° C. The penetration is measured in tenths of a millimeter (deci-millimeter, 0.1 mm, dmm) and the deeper the needle penetrates the bitumen specimen, the larger the reported value, and the softer the bitumen.

Furthermore, bitumen compositions intended for use in bitumen roofing products may have a penetration value, at 25° C. of greater than about 10 dmm (0.1 millimeters), such as for example, greater than about 12 dmm. It is desired that the bitumen composition has a penetration value, in dmm, of greater than about 10, 12, 15, 20 or 25, and independently, of not more than about 75, 70, 60, 55, 50, 45, 40, 35, 30, 25 or 20.

As noted above, the bitumen composition contemplated herein comprises a paving grade bitumen feedstock, alow molecular weight polyolefin, and a carbon footprint reducing material. All types of bitumen feedstock, naturally occurring, synthetically manufactured and modified, may be used in accordance with the bitumen compositions contemplated herein. Naturally occurring bitumen is inclusive of native rock bitumen, lake bitumen, and the like. Synthetically manufactured bitumen is often a byproduct of petroleum refining operations, blended bitumen, cracked, residual or recycled bitumen, petroleum bitumen, propane bitumen, straight-run bitumen, thermal bitumen, and the like. Modified bitumen includes base bitumen (e.g., neat or unmodified bitumen that can be naturally occurring or synthetically manufactured) modified with elastomers, plastomers, or various combinations of these.

The bitumen Performance Grade (PG) rating system categorizes bitumen compositions used in bitumen products based on the bitumen composition's performance at different temperatures. An bitumen composition having a PG rating of about 64-22, for example, means that the bitumen composition can be used in a climate where the pavement end product reaches temperatures as high as +64° C. and as low as −22° C. Temperatures outside the PG range of the bitumen composition usually lead to deterioration of the bitumen product in which it is used.

“Base bitumen,” as this term is used herein is bitumen, or bitumen, which is defined by the ASTM D 8 as a dark brown to black cementitious material in which the predominant constituents are bitumens that occur in nature or are obtained in petroleum processing. Bitumens typically contain saturates, aromatics, resins and asphaltenes.

The type of paving bitumen suitable for paving applications is commonly referred to as “paving grade bitumen,” or “paving bitumen,” or “bitumen cement.” Bitumen suitable for roofing applications is commonly referred to as “roofing flux,” “flux bitumen,” or simply “flux.” In general, paving bitumen is harder than roofing flux, as indicated by their penetration grade. The most popularly used paving bitumen has a penetration around 50/70 or 60/90 dmm (0.1 millimeters) at 25° C., and on the other hand, roofing flux's penetration is generally above 150-200 dmm at 25° C. Accordingly, roofing flux won't be used directly, especially for roofing shingle manufacturing, because it is too soft. As described above, the “air blow” process is applied to roofing flux to make it harder and, therefore, more suitable for roofing applications. During the air blow process, air is bubbled through hot liquid roofing flux for a certain amount of time (e.g., 2 to 8 hours). Oxygen in the air reacts with bitumen flux and its stiffness is thereby increased dramatically, indicated by penetration of the roofing flux dropping from greater than about 150-200 dmm to about 20 dmm. The product of such air blow processes is called “blown coating” or “oxidized bitumen” and is useful for making roofing products, such as roofing shingles.

“Non-oxidized base bitumen,” as this term is used herein, includes base bitumen that has not been subjected to or undergone an oxidizing, or air blowing, step as that process has been described hereinabove. In other words, paving grade bitumen or roofing flux type bitumen is used in the bitumen compositions contemplated herein without first performing an air blowing step to harden it before combining with the low molecular weight (MW) polyolefin or inorganic filler, recycled material, performance additives, etc.

Adding low MW polyolefins to bitumen compositions, in amounts from about 0.1 to about 15 percent by weight of the bitumen composition, improves heat resistance properties of the bitumen compositions and of roofing products that incorporate such bitumen compositions. “Low MW polyolefin,” as this term is used herein, means a polyolefin-containing polymer, or a blend of two or more polyolefin-containing polymers, each of which has a weight average molecular weight (Mw) of from about 500 to about 30,000 Daltons, and comprises from about 80 to about 100 wt. %, based on the total weight of the low MW polyolefin, of one or more olefinic monomers selected from: ethylene, propylene, butene, hexene, and octene. Thus, the low MW polyolefins may be homopolymers comprising only a single type of olefin monomer, or copolymers comprising two or more types of olefin monomers. Furthermore, low MW polyolefins, as this term is used herein, include but are not limited to polyolefin waxes, i.e., polyolefins which are solid at or near room temperature and have low viscosity when above their melting point. The low MW polyolefins may be functionalized. Functionalized low MW polyolefins may be homopolymers or copolymers. Further, functionalized low MW polyolefins comprise one or more functional groups including for example, without limitation, an acid, an ester, an amine, an amide, an ether, and anhydride. Additionally, the low MW polyolefins may be oxidized.

In an exemplary embodiment, the low MW polyolefin has an olefin content of from about 50 to about 100 wt. %, based on the total weight of the low MW polyolefin. It is desired that the low MW polyolefin has an olefin content in wt. %, based on the total weight of the low MW polyolefin, of at least about 55, 60, 65, 70, 75, 80, 85, 90, or 95, and independently, of not more than about 98, 95, 92, 90, 85, 80, or 75.

As already mentioned, the low MW polyolefin has a Mw of from about 500 to about 30,000 Daltons. It is desired that the low MW polyolefin has a Mw in Daltons of at least about 500, 1,000, 2,000, 3,000, 4,000, 5,000, 6,000, 7,000, 8, 000, or 9,000 and independently, of not more than about 30,000, 28,000, 26,000, 24,000, 22,000, 20,000, 18,000, 15,000, 12,000, or 10,000. Where the low MW polyolefin comprises a combination of more than one type of polyolefin, the Mw of each type of polyolefin in the combination shall individually be within the above-stated range of about 500 to about 30,000 Daltons.

Generally, suitable low MW polyolefins include, without limitation, polyethylene homopolymers, polypropylene homopolymers, copolymers of two or more of ethylene, propylene, butene, hexane and octene, functionalized derivatives of said homopolymers, functionalized derivatives of said copolymers, or combinations of unfunctionalized and functionalized low MW polyolefins. Thermally degraded (TD) waxes made from virgin or recycled plastic waste, and Fischer-Tropsch (F-T) waxes, i.e., those that satisfy the above-defined characteristics of low MW polyolefins, may also be used in the bitumen compositions contemplated and described herein.

Examples of suitable functionalized low MW polyolefins include, without limitation, alkylene maleic anhydride, maleated polyethylene, maleated polypropylene, ethylene acrylic acid copolymers, ethylene vinyl acetate copolymers, oxidized polyethylene, especially oxidized high density polyethylene, and combinations thereof. Alkylene maleic anhydride, can be ethylene maleic anhydride, propylene maleic anhydride, or a combination thereof. Alternatively, TD wax produced from virgin or recycled plastic waste. High Density Polyethylene (HDPE) is a commercially available material having very low molecular weight (500-30,000 Dalton; LMW) or very high molecular weight (>106 Dalton; HMW) chains. In this disclosure, oxidized high density polyethylenes are defined as polyethylenes with a density of about 0.94 to about 1.0 gm/cm³ as determined by ASTM D-1505 at 23+/−0.1° C.

One category of suitable low MW polyolefin includes certain HONEYWELL TITAN® polyolefins, which include homopolymers of polyethylene or polypropylene and are commercially available from Honeywell International Inc., located in Charlotte, N.C., U.S.A. More particularly, one or more of the HONEYWELL TITAN® 8880, 8570, 8650, 8903, and 8822 are suitable for use as the low MW polyolefin.

In an exemplary embodiment, the low MW polyolefin comprises a functionalized high-density polyethylene such as HONEYWELL TITAN® 8903 and Honeywell Titan 8058, Propylene maleic anhydride copolymer such as Honeywell Titan 8822, low density polyethylene (LDPE) Homopolymer such as Honeywell Titan 8422 and Honeywell Titan 8183.

In an exemplary embodiment, the low MW polyolefin is present in the bitumen composition in an amount of from about 0.1 to about 15 percent by weight (wt. %) of the bitumen composition. It is desired that the low MW polyolefin is present in the bitumen composition in an amount, in wt. %, based on the total weight of the bitumen composition of at least about 0.1, 0.2, 0.3, 0.4, 0.5, 0.6, 0.7, 0.8, 0.9, 1.0, 1.2, 1.5, 1.8, 2.0, 2.2, 2.5, or 3.0 and independently, of not more than about 15, 12, 10, 8, 6, 5, 4.5, 4.0, 3.5, 3.0, 2.5, 2, 1.5, 1.4, 1.3, 1.2, 1.1 or 1. For example, the total content of low MW polyolefin in the bitumen composition may be from about 0.5 to about 10 wt. %, or from about 0.5 to about 7 wt. %, or from about 1 to about 6 wt. %, or from about 2 to about 5 wt. %, or even from about 0.5 to 2.0 wt. %, based on the total weight of the bitumen composition.

Performance additives such as plastomers, elastomers, or both are well-known in the industry for use in bitumen roofing products to expand the temperature ranges at which such products can be used without serious defect or failure. The bitumen compositions may comprise one or more performance additives that are present in a total amount of from about 1 to about 20 wt. % and preferably about 5 to about 15 wt. %, based on the total weight of the bitumen composition. Non-limiting examples of elastomers suitable for modifying the non-oxidized base bitumen include natural or synthetic rubbers including ground recycled tire rubber (RTR), ground tire rubber (GTR), devulcanized GTR, butyl rubber, styrene/butadiene rubber (SBR), styrene/ethylene/butadiene/styrene terpolymers (SEBS), polybutadiene, polyisoprene, ethylene/propylene/diene (EPDM) terpolymers, ethylene/n-butyl acrylate/glycidyl methacrylate terpolymers, and styrene/conjugated diene block or random copolymers, such as, for example, styrene/butadiene including styrene/butadiene/styrene copolymer (SBS), styrene/isoprene, styrene/isoprene/styrene (SIS) and styrene/isoprene-butadiene block copolymer. The block copolymers may be branched or linear and may be a diblock, triblock, tetrablock or multiblock.

In some embodiments of the bitumen compositions contemplated and described herein, an elastomer, such as recycled tire rubber may be present in an amount of from about 1 to about 20 wt. %, based on the total weight of the bitumen composition. For example, in some embodiments, the elastomer is present in the bitumen composition in an amount, in wt. %, based on the total weight of the bitumen composition, of at least about 1, 2, 3, 5, 7, 8, or 9 and independently, of not more than about 15, 14, 13, 12, 11, 10, or 9. In an exemplary embodiment, the elastomer is an SBS copolymer and is present in an amount of, for example without limitation, from about 5 to about 15 wt. %, or from about 6 to about 13 wt. %, or from about 8 to about 12 wt. %, or from about 8 to about 11 wt. %, or even from about 9 to 10 wt. %, based on the total weight of the bitumen composition. In embodiments of the bitumen composition for use in roofing applications and products which comprises an recycled tire rubber, the amount of low MW polyolefin present and still providing performance benefits may be as little as about 2 wt. % or less, or even, 1.2 wt. % or less, based on the total weight of the bitumen composition. The recycled tire rubber can be ground to a size between about 20 to about 200 mesh and preferably about 40 to mesh, more preferably about 60 to about 200 mesh, even more preferably about 80 mesh to about 200 mesh.

Non-limiting examples of plastomers suitable for modifying the base bitumen, e.g., for high temperature performance, include thermoplastic polyolefins which soften when heated but only melt at significantly higher temperatures such as polyethylene, oxidized polyethylene, polypropylene, oxidized polypropylene, and functionalized polyolefins such as maleated polyethylene, maleated polypropylene, ethylene acrylic acid copolymers and the like.

In an exemplary embodiment, a roofing bitumen composition is formed from pavement-grade bitumen feedstock. The roofing bitumen composition includes a paving grade bitumen feedstock, alow MW polyolefin, and 5-60% of a material selected from the group of kraft lignin, recycled fibrous material, recovered bitumen from waste roofing shingles, ground waste tire rubber, and combinations thereof.

Another exemplary embodiment provides a roofing bitumen composition as described above that has a softening point of 88.9° C. to 112.8° C. and a penetration at 25° C. of minimum 15 dmm and is further having less than about 91 wt. % and more than about 82 wt. % paving grade bitumen feedstocks. This paving grade bitumen feedstock can be formed of 9.0-15.0 wt. % recycled ground rubber, 2-4 wt. % oxidized high-density polyethylene homopolymer, and 1-2 wt. % of propylene maleic anhydride. This roofing bitumen composition reduces the carbon footprint from traditional bitumen roofing materials and has superior properties.

Another exemplary embodiment provides a roofing bitumen composition as described above that has a softening point of 89.5° C. to 114.2° C. and a penetration at 25° C. of minimum 15 dmm and is further composed of from about 76% to about 95% by weight paving grade bitumen feedstock, 5% to 20% kraft lignin, 1-3% by weight oxidized high-density polyethylene homopolymer, and 1-3% by weight propylene maleic anhydride. This roofing bitumen composition reduces the carbon footprint from traditional bitumen roofing materials and has superior properties.

Another exemplary embodiment provides a roofing bitumen composition as described above that has a softening point of 94.0° C. to 107.6° C. and a penetration at 25° C. of minimum 15 dmm and is further composed of from about 37% to about 50% by weight paving grade bitumen feedstock, 50% to 60% by weight bitumen retrieved from recycled asphalt shingle (RAS) or reclaimed asphalt pavement (RAP), 3% by weight oxidized high-density polyethylene homopolymer, alkylene maleic anhydride, polyethylene homopolymer, Fisher-Tropsch wax, or combinations thereof, wherein all amounts are based on the total weight of the roofing bitumen composition. This roofing bitumen composition reduces the carbon footprint from traditional bitumen roofing materials and has superior properties.

In accordance with another exemplary embodiment, a method for making a roofing bitumen composition for use in roofing applications is provided. The roofing bitumen composition is made by a method including mixing a paving grade bitumen feedstock 35% to 95% by weight, 1-5% of alow MW polyolefin, and 5% to 60% by weight a carbon footprint reducing material selected from the group of kraft lignin, recycled fibrous material, recovered bitumen from waste roofing shingle (RAS) or reclaimed asphalt pavement (RAP), ground waste tire rubber, and combinations thereof. The material can be prepared by mixing the materials at an elevated temperature using various mixer speeds. This method results in a roofing bitumen composition with a decreased carbon footprint as compared to an oxidized bitumen from roof-grade bitumen with a reduction of greenhouse gas emissions of 5-60%. The carbon footprint reducing material and low MW polyolefin are added to molten base bitumen (e.g., NA PG 64-22 #1) at 140° C. to about 200° C. A high or low shear mixer can be used to blend the mixture at about 200 to about 20,000 rpm and preferably 3,000 rpm for about 1 to about 4 hours.

In an exemplary embodiment, an bitumen material useful for producing roofing products and containing the bitumen composition described hereinabove is provided. Such a filled bitumen material comprises the roofing bitumen composition described, and an inorganic filler. The bitumen composition is generally present in the filled bitumen material in an amount of from about 20 to about 99 wt. % and preferably between 30 and 60 wt. %, and the inorganic filler is present in a total amount of from about 1 to about 80 wt. %, and preferably between 20 to 70 wt. %, based on the total weight of the filled bitumen material.

Inorganic fillers suitable for addition to filled bitumen materials for roofing applications, such as those described herein, may be any inorganic fillers, ground reclaimed asphalt pavement (RAP), ground recycled asphalt shingle (RAS), or a combination of these, known now or in the future to persons of ordinary skill in the art, to be appropriate for inclusion in roofing products. Depending upon the intended use of the filled bitumen material, i.e., paving or roofing and, if roofing, bitumen roofing shingles, membranes or waterproof membranes, the inorganic filler may be mineral filler, fly ash, carbon black, or a combination of these. Mineral filler is typically ground stone or mineral, such as, for example, stone dust, limestone particles, and talc, among others. inorganic fillers, ground RAP, ground RAS is typically ground to a particle size of about 180 μm or less.

The fibrous material can be long or short fibers formed of natural, synthetic, or mineral fibers. These materials can be recycled or reused fibers. Optionally, the fibrous materials can be Kraft lignin obtained from Kraft pulp. In the pulping process, the lignin macromolecules are fractured, the molecular weight is decreased, the lignin is dissolved in alkaline solution, making the solution turn dark brown.

In an exemplary embodiment, the filled bitumen material is compounded for a roofing application and the inorganic filler is ground stone or mineral. The filled bitumen material comprises the bitumen composition and the inorganic filler present in amounts of from about 20 to about 99 wt. % and from about 1 to about 80 wt. % of the filled bitumen material, respectively. The bitumen composition itself comprises non-oxidized base bitumen, the low MW polyolefin, the carbon footprint reducing material, and optionally one or more performance additives, e.g., elastomers, plastomers, or combinations thereof. The low MW polyolefinis present in amounts of from about 1 to about 20 wt. % and from about 1 to about 5 wt. %, and the carbon footprint reducing material is present in the amount of from about 5 to about 60 wt. %, based on the total weight of the bitumen composition, respectively.

In an exemplary embodiment, a method for making a filled bitumen composition is provided. The method comprises combining a low MW polyolefin, a non-oxidized base bitumen, and a carbon footprint reduction material at an elevated temperature to form an unfilled bitumen composition or recycled material.

The unfilled bitumen composition can be prepared by mixing the materials at an elevated temperature using various mixer speeds. This method results in an unfilled bitumen composition with a decreased carbon footprint as compared to an oxidized bitumen from roof-grade bitumen with a reduction of greenhouse gas emissions of 5-60%. The carbon footprint reducing material and low MW polyolefin are added to molten base bitumen (e.g., NA PG 64-22 #1) at about 140° C. to about 200° C. A high or low shear mixer can be used to blend the mixture at about 200 to about 20,000 rpm and preferably 3,000 rpm for 1 to 4 hours. A filler then is combined with the unfilled bitumen composition to form a filled bitumen composition, the filled bitumen composition can be prepared by mixing the unfilled bitumen composition and the filler at an elevated temperature using various mixer speeds. In one example, the unfilled bitumen composition and the filler is mixed at about 140° C. to about 200° C. using a mixer at about 200 to about 2,000 rom for about 1 to about 4 hours.

In another exemplary embodiment, the carbon footprint reduction material and the low MW polyolefin are mixed to form a blend that is then combined with the non-oxidized base bitumen at the elevated temperature to form the bitumen composition. The blend can be a physical mixture of the two, a melt blend that can be cooled and shaped into a flake, pellet, briquette or other shape prior to being combined with the non-oxidized base bitumen, or a melt blend that is added directly to the non-oxidized base bitumen. In another example, the carbon footprint reducing material and the low MW polyolefin are added separately to the non-oxidized base bitumen at the elevated temperature to form the bitumen composition. At least a portion of the carbon footprint reducing material may be added to the non-oxidized base bitumen prior to, concurrently, or subsequently to the addition of the low MW polyolefin.

### EXAMPLES

The following are examples of roofing bitumen compositions modified with low MW polyolefins, carbon footprint reducing material and having reduced greenhouse gas and energy requirements, with each of the components set forth in weight percent. The examples are provided for illustration purposes only and are not intended to limit the various embodiments of the bitumen compositions in any way.

Summary of Test Methods: Softening Point, ° C. (SP): Measured according to the ASTM D36 method (a “ring and ball” method, “R&B SP”). Penetration, dmm at 25° C.

(PEN): Measured according to the ASTM D5 method. Molecular Weight, Mw: All molecular weight reported in these examples are weight average molecular weights measured by gel permeation chromatography (GPC), which is a technique generally known in the art. For the purpose of GPC, the sample to be measured is dissolved in 1,2,4-trichlorobenzene at 140° C. at a concentration of 2.0 mg/ml. The solution (200 uL) is injected into the GPC containing two PLgel 5 μm Mixed-D (300×7.5 mm) columns held at 140° C. with a flow rate of 1.0 mL/minute. The instrument is equipped with two detectors (refractive index and viscosity detector). The molecular weight (Mw) is determined using a calibration curve generated from a set of linear polyethylene narrow Mw standards.

In the following examples, only scope 3 carbon footprint is used for the calculation. This invention can potentially deliver higher carbon footprint reduction than those showed in the following examples due to potential reduction in processing temperature and processing time when compared with the traditional “air blow” process used today to produce oxidized bitumen (or blown coating) for roofing product production. For non-oxidized base bitumen (for example, NA PG 64-22 #1), a scope 3 carbon footprint of 0.64 kgCO2e/kg [GWP100] was used for the calculation with reference to “Life Cycle Assessment of Asphalt Binder, 2019, Executive Summary” in “Asphalt Institute: LCA of Asphalt Binder” published by Asphalt Institute in 2019. For oxidized bitumen, a scope 3 carbon footprint of about 0.80 to about 1.00 kgCO2e/kg [GWP100] was used based on Honeywell's internal calculation. For carbon footprint reducing material, such as recycled tire rubber (RTR), kraft lignin, recovered bitumen from waste roofing shingle (RAS) or reclaimed asphalt pavement (RAP), due to their waste (recycling) nature, a scope 3 carbon footprint of 0 kgCO2e/kg [GWP100] was used for the calculation of carbon footprint value of various compositions in the following examples.

Example 1 shows the effect of different amounts of paving bitumen, Low MW polyolefins and recycled tire rubber (RTR) on the physical properties and carbon footprint of the roofing bitumen. The paving grade bitumen was heated in a metal can to an elevated temperature of about 180° C., to form a hot liquid bitumen, and the low MW polyolefins and the recycled tire rubber (RTR) were added to the molten base bitumen (NA PG 64-22 #1) at about 180° C. A low shear mixer is used to blend the mixture at about 800 rpm for about 4 hrs. The sample compositions and test results are shown below in Table 1.

The softening point and penetration tests were conducted for each sample using the prescribed ASTM methods. Also shown are the calculated scope 3 carbon footprints for each of the mixtures as well as an estimated reduction in kgCO2e versus oxidized bitumen using both 1.0 and 0.8 kgCO2e for oxidized bitumen.

TABLE 1

| | | | C | B | C | B | C |
|---|---|---|---|---|---|---|---|
| | | | RTR | RTR | RTR | RTR | RTR |
| Composition | | | 1 | 1-1 | 2 | 2-1 | 3 |
| NA PG64-22 #1 wt. % | | | 88 | 84 | 91 | 87 | 88 |
| RTR #1 (60 mesh) wt. % | | | 12 | 12 | | | |
| RTR #2 (140 mesh) wt. % | | | | | 9 | 9 | 12 |
| Honeywell Titan® | | | | 3.0 | | 2.4 | |
| 8903 wt. % | | | | | | | |
| Honeywell Titan® | | | | 1.0 | | 1.6 | |
| 8822 wt. % | | | | | | | |
| Total | | | 1.00 | 1.00 | 1.00 | 1.00 | 1.00 |
| | Temp | | | | | | |
| Original Binder | (° C.) | Spec | | | | | |
| Penetration, dmm | 25 | min 15 | 58.6 | 41.9 | 59.3 | 42 | 55.9 |
| Softening Point, C. | NA | 88-160 | 59.4 | 98.9 | 59.2 | 88.9 | 62.2 |
| carbon footprint | NA | | NA | 0.70 | NA | 0.72 | NA |
| (kgCO2e) | | | | | | | |
| carbon footprint | 0.8 | | NA | 13% | NA | 10% | NA |
| reduction vs. | | | | | | | |
| oxidized bitumen | | | | | | | |
| carbon footprint | 1 | | NA | 30% | NA | 28% | NA |
| reduction vs. | | | | | | | |
| oxidized bitumen | | | | | | | |

| | | | C | B | B | B | B | B | B | C | B |
|---|---|---|---|---|---|---|---|---|---|---|---|
| | | | RTR | RTR | RTR | RTR | RTR | RTR | RTR | RTR | RTR |
| Composition | | | 3 | 3-1 | 3-2 | 3-3 | 3-4 | 3-5 | 3-6 | 4 | 4-1 |
| NA PG64-22 #1 wt. % | | | 88 | 85 | 84 | 84 | 83 | 83 | 82 | 85 | 82 |
| RTR #1 (60 mesh) wt. % | | | | | | | | | | | |
| RTR #2 (140 mesh) wt. % | | | 12 | 12 | 12 | 12 | 12 | 12 | 12 | 15 | 15 |
| Honeywell Titan® | | | | 2.0 | 2.4 | 2.8 | 4.0 | 3.0 | 4.0 | | 2.0 |
| 8903 wt. % | | | | | | | | | | | |
| Honeywell Titan® | | | | 1.0 | 1.6 | 1.2 | 1.0 | 2.0 | 2.0 | | 1.0 |
| 8822 wt. % | | | | | | | | | | | |
| Total | | | 1.00 | 1.00 | 1.00 | 1.00 | 1.00 | 1.00 | 1.00 | 1.00 | 1.00 |
| | Temp | | | | | | | | | | |
| Original Binder | (° C.) | Spec | | | | | | | | | |
| Penetration, dmm | 25 | min 15 | 55.9 | 36.7 | 39.5 | 41.5 | 38.9 | 38.4 | 35 | 48.3 | 32.3 |
| Softening Point, C. | NA | 88-160 | 62.2 | 82.6 | 97.1 | 90.6 | 92.9 | 106.6 | 112.8 | 66.1 | 91.1 |
| carbon footprint | NA | | NA | NA | 0.70 | 0.70 | 0.70 | 0.70 | 0.76 | NA | 0.64 |
| (kgCO2e) | | | | | | | | | | | |
| carbon footprint | 0.8 | | NA | NA | 13% | 13% | 13% | 13% | 5% | NA | 20% |
| reduction vs. | | | | | | | | | | | |
| oxidized bitumen | | | | | | | | | | | |
| carbon footprint | 1 | | NA | NA | 30% | 30% | 30% | 30% | 24% | NA | 36% |
| reduction vs. | | | | | | | | | | | |
| oxidized bitumen | | | | | | | | | | | |

Penetration, dmm as measured according to the ASTM method D5
Softening Point, C
as measured according to the ASTM method D36; underlined values are unacceptable
C RTR=Control with Recycled Rubber Tire
   B RTR=Blended with Recycled Rubber Tire Material
   Underlined results are unacceptable
   Honeywell Titan® 8903: oxidized high density polyethylene homopolymer
   Honeywell Titan® 8822: propylene maleic anhydride

Example 2 shows the effect of different amounts of paving bitumen, Honeywell Titan® 8903, Honeywell Titan® 8822 and fibrous materials such as recycled Kraft Lignin on the carbon footprint of the roofing bitumen materials. The Paving grade bitumen (NA PG 64-22) was heated in a metal can to an elevated temperature of about 160° C., to form a hot liquid bitumen, and the low MW polyolefins and the kraft lignin were added to the hot liquid bitumen. A high shear mixer was used to blend the mixture at 3000 rpm for 1 hr at 160 C. The sample compositions and test results are shown in Table 2 below.

The softening point and penetration tests results were determined for each sample using the ASTM methods. Also shown are the calculated scope 3 carbon footprints for each of the mixtures as well as an estimated reduction in Kg CO2 eq versus oxidized bitumen using both 1.0 and 0.8 kg CO2 eq for oxidized bitumen.Kg.

### Table 2a and 2b

| | | | C | B | C | B | C |
|---|---|---|---|---|---|---|---|
| | | | L | L | L | L | L |
| Composition | | | 1 | 1 | 2 | 2 | 3 |
| NA PG64-22 #1 wt. % | | | 95 | 91 | 90 | 86 | 85 |
| kraft lignin wt. % | | | 5 | 5 | 10 | 10 | 15 |
| Honeywell Titan ® | | | | 3.0 | | 3.0 | |
| 8903 wt. % | | | | | | | |
| Honeywell Titan ® | | | | 1.0 | | 1.0 | |
| 8822 wt. % | | | | | | | |
| Total | | | 1.00 | 1.00 | 1.00 | 1.00 | 1.00 |
| | Temp | | | | | | |
| Original Binder | C. ) | Spec | | | | | |
| Penetration, dmm | 25 | min 15 | 52.7 | 28.8 | 51.5 | 36.1 | 50.1 |
| Softening Point, C. | NA | 88-160 | 53.9 | 81.4 | 54.5 | 89.5 | 55.3 |
| carbon footprint | NA | | NA | 0.74 | NA | 0.71 | NA |
| (kgCO2e) | | | | | | | |
| carbon footprint | 0.8 | | NA | 7 | NA | 11 | NA |
| reduction vs. | | | | | | | |
| oxidized bitumen | | | | | | | |
| carbon footprint | 1 | | NA | 26 | NA | 29 | NA |
| reduction vs. | | | | | | | |
| oxidized bitumen | | | | | | | |

| | | | C | C | B | B | B | B |
|---|---|---|---|---|---|---|---|---|
| | | | L | L | L | L | L | L |
| Composition | | | 3 | 3-1 | 3-2 | 4 | 4-1 | 4-2 |
| NA PG64-22 #1 wt. % | | | 85 | 81 | 81 | 80 | 76 | 76 |
| kraft lignin wt. % | | | 15 | 15 | 15 | 20 | 20 | 20 |
| Honeywell Titan ® | | | | 3.0 | 1.0 | | 3.0 | 1.0 |
| 8903 wt. % | | | | | | | | |
| Honeywell Titan ® | | | | 1.0 | 3.0 | | 1.0 | 3.0 |
| 8822 wt. % | | | | | | | | |
| Total | | | 1.00 | 1.00 | 1.00 | 1.00 | 1.00 | 1.00 |
| | Temp | | | | | | | |
| Original Binder | C. ) | Spec | | | | | | |
| Penetration, | 25 | min | 50.1 | 36.9 | 33.1 | 39.7 | 34.4 | 29.5 |
| dmm | | 15 | | | | | | |
| Softening Point, | NA | 88- | 55.3 | 94.7 | 106.1 | 57.3 | 98 | 114.2 |
| C. | | 160 | | | | | | |
| carbon footprint | NA | | NA | 0.68 | 0.68 | NA | 0.64 | 0.65 |
| (kgCO2e) | | | | | | | | |
| carbon footprint | 0.8 | | NA | 15 | 15 | NA | 20 | 19 |
| reduction vs. | | | | | | | | |
| oxidized | | | | | | | | |
| bitumen | | | | | | | | |
| carbon footprint | 1 | | NA | 32 | 32 | NA | 36 | 35 |
| reduction vs. | | | | | | | | |
| oxidized | | | | | | | | |
| bitumen | | | | | | | | |

### Key

CL=Control Lignin
BL=Blend Lignin
Underlined results are unacceptable
   Honeywell Titan® 8903: oxidized high density polyethylene homopolymer
   Honeywell Titan® 8822: propylene maleic anhydride

Example 3: Effect of different amounts of paving bitumen, a low MW polyolefin, and recycled bitumen roofing material on the physical properties and scope 3 carbon footprint of the roofing bitumen compound. The roofing bitumen composition is made by a method including mixing a paving grade bitumen feedstock, a low MW polyolefin, and recovered bitumen from waste roofing materials. The material can be prepared by mixing the materials at about 180° C. for about 1 hr using a low shear mixer at about 800 rpm. This method results in a roofing bitumen composition with a decreased scope 3 carbon footprint as compared to an oxidized bitumen from oxidized roof-grade bitumen with a reduction of greenhouse gas emissions of 5-60%.

The softening point and penetration tests results were determined for each sample using the ASTM methods. Also shown are the calculated scope 3 carbon footprints for each of the mixtures as well as an estimated reduction in kgCO2e versus oxidized bitumen using both 1.0 and 0.8 kgCO2e for oxidized bitumen.

| | | | C | B | C | B | B | B | B |
|---|---|---|---|---|---|---|---|---|---|
| | | | RAS | RAS | RAS | RAS | RAS | RAS | RAR |
| Composition | | | 1 | 1 | 2 | 2 | 3 | 4 | 5 |
| NA PG64-22 #1 wt. % | | | 50 | 47 | 40 | 37 | 37 | 37 | 37 |
| NA PG64-22 #2 wt. % | | | | | | | | | |
| NA PG64-22 #3 wt. % | | | | | | | | | |
| bitumen recovered from | | | 50 | 50 | 60 | 60 | 60 | 60 | 60 |
| recycled roofing shingle | | | | | | | | | |
| (RAS) wt. % | | | | | | | | | |
| Honeywell Titan ® | | | | 3.0 | | 3.0 | | | |
| 8903 | | | | | | | | | |
| Honeywell Titan ® | | | | | | | 3.0 | | |
| 8822 | | | | | | | | | |
| Honeywell Titan ® | | | | | | | | 3.0 | |
| 8422 | | | | | | | | | |
| Honeywell Titan ® | | | | | | | | | 3.0 |
| 8183 | | | | | | | | | |
| Honeywell Titan ® | | | | | | | | | |
| 8058 | | | | | | | | | |
| Sasobit | | | | | | | | | |
| RF-1000 | | | | | | | | | |
| Total | | | 1.00 | 1.00 | 1.00 | 1.00 | 1.00 | 1.00 | 1.00 |
| Original Binder | Temp | Spec | | | | | | | |
| Penetration, dmm | 25 | min 15 | 22.4 | 27.0 | 21.6 | 19.3 | 18.6 | 18.2 | 21.5 |
| Softening Point, C. | NA | 88-160 | 78.9 | 85.0 | 82.2 | 96.3 | 96.3 | 97.6 | 994.0 |
| carbon footprint | NA | | NA | NA | | 0.47 | 0.48 | 0.47 | 0.47 |
| (kgCO2e) | | | | | | | | | |
| carbon footprint | 0.8 | | NA | NA | | 41 | 40 | 41 | 41 |
| reduction vs. | | | | | | | | | |
| oxidized bitumen % | | | | | | | | | |
| carbon footprint | 1 | | NA | NA | | 53 | 52 | 53 | 53 |
| reduction vs. | | | | | | | | | |
| oxidized bitumen % | | | | | | | | | |

| | | | B | B | B | B | B | B | B |
|---|---|---|---|---|---|---|---|---|---|
| | | | RAS | RAS | RAS | RAS | RAS | RAS | RAS |
| Composition | | | 6 | 7 | 8 | 9 | 10 | 11 | 12 |
| NA PG64-22 #1 wt. % | | | 37 | 37 | 37 | | | | |
| NA PG64-22 #2 wt. % | | | | | | 37 | 37 | | |
| NA PG64-22 #3 wt. % | | | | | | | | 37 | 37 |
| bitumen recovered | | | 60 | 60 | 60 | 60 | 60 | 60 | 60 |
| from recycled | | | | | | | | | |
| roofing shingle | | | | | | | | | |
| (RAS) wt. % | | | | | | | | | |
| Honeywell Titan ® | | | | | | 3.0 | | 3.0 | |
| 8903 | | | | | | | | | |
| Honeywell Titan ® | | | | | | | | | |
| 8822 | | | | | | | | | |
| Honeywell Titan ® | | | | | | | | 3.0 | |
| 8422 | | | | | | | | | |
| Honeywell Titan ® | | | | | | | | | |
| 8183 | | | | | | | | | |
| Honeywell Titan ® | | | 3.0 | | | | | | |
| 8058 | | | | | | | | | |
| Sasobit ® | | | | 3.0 | | | | | |
| Honeywell RF-1000 | | | | | 3.0 | | | | |
| Total | | | 1.00 | 1.00 | 1.00 | 1.00 | 1.00 | 1.00 | 11.00 |
| Original Binder | Temp | Spec | | | | | | | |
| Penetration, dmm | 25 | min 15 | 20.7 | 21.7 | 23.8 | 18.1 | 15.5 | 16.2 | 17.0 |
| Softening Point, C. | NA | 88-160 | 94.5 | 94.0 | 91.2 | 101.7 | 103.5 | 107.6 | 107.1 |
| carbon footprint | NA | | 0.47 | 0.47 | 0.47 | 0.47 | 0.47 | 0.47 | 0.47 |
| (kgCO2e) | | | | | | | | | |
| carbon footprint | 0.8 | | 41 | 41 | 41 | 41 | 41 | 41 | 41 |
| reduction vs. | | | | | | | | | |
| oxidized bitumen % | | | | | | | | | |
| carbon footprint | 1 | | 53 | 53 | 53 | 53 | 53 | 53 | 53 |
| reduction vs. | | | | | | | | | |
| oxidized bitumen % | | | | | | | | | |

CL=Control recycled roofing shingle
BL=Blend recycled roofing shingle
Underlined results are unacceptable
Honeywell Titan® 8903: oxidized high density polyethylene homopolymer
Honeywell Titan® 8822: propylene maleic anhydride
Honeywell Titan® 8422: low density polyethylene homopolymer
Honeywell Titan® 8183: low density polyethylene homopolymer
Honeywell Titan® 8058: oxidized high density polyethylene homopolymer
Sasobit®: Fischer-Tropsch wax
Honeywell RF-1000: Fischer-Tropsch wax

While at least one exemplary embodiment has been presented in the foregoing Detailed Description, it should be appreciated that a vast number of variations exist. It should also be appreciated that the exemplary embodiment or exemplary embodiments are only examples, and are not intended to limit the scope, applicability, or configuration of the invention in any way. Rather, the foregoing Detailed Description will provide those skilled in the art with a convenient road map for implementing an exemplary embodiment of the invention, it being understood that various changes may be made in the function and arrangement of elements described in an exemplary embodiment without departing from the scope of the invention as set forth in the appended claims and their legal equivalents.

What is claimed:

1. A roofing bitumen composition comprising:
a) a bitumen feedstock;
b) polyolefin; and
c) about 5% to 60%, based on a total weight of the roofing bitumen composition, of a carbon footprint reducing material selected from the group of kraft lignin, fibrous material, recovered bitumen from recycled asphalt shingle (RAS) or reclaimed asphalt pavement (RAP), recycled tire rubber (RTR), and combinations thereof.

2. The roofing bitumen composition of claim 1, where the bitumen feedstock is a paving grade bitumen.

3. The roofing bitumen composition in claim 1, where the polyolefin is low molecular weight polyolefin selected from the group of polyethylene homopolymer, oxidized polyethylene homopolymer, polypropylene homopolymer, maleated polyethylene, maleated polypropylene, ethylene vinyl acetate copolymer, ethylene acrylic acid copolymer, Fischer-Tropsch waxes, thermally degraded waxes, and combinations thereof.

4. The roofing bitumen composition in claim 3, comprising 1%-5% weight percentage low molecular weight polyolefin, based on a total weight of the roofing bitumen composition.

5. The roofing bitumen composition of claim 3, wherein the oxidized polyethylene homopolymer is an oxidized high-density polyethylene homopolymer.

6. The roofing bitumen composition of claim 5, comprising 1%-5% oxidized high-density polyethylene homopolymer, based on a total weight of the roofing bitumen composition.

7. The roofing bitumen composition of claim 3, comprising 1%-5% maleated polypropylene, based on a total weight of the roofing bitumen composition.

8. The roofing bitumen composition of claim 1, wherein the softening point of the roofing bitumen composition is between 88° C. to about 160° C. as determined according to method ASTM D36.

9. The roofing bitumen composition of claim 8, wherein the softening point of the roofing bitumen composition is between 90° C. to about 100° C. as determined according to method ASTM D36.

10. The roofing bitumen composition of claim 1, wherein the penetration of the roofing bitumen composition at 25° C. is greater than 15 dmm as determined according to method ASTM D5.

11. The roofing bitumen composition of claim 10, wherein the penetration of the roofing bitumen composition at 25° C. is between 15 dmm to about 25 dmm as determined according to method ASTM D5.

12. A roofing shingle composition comprising:
a) bitumen feedstock;
b) low molecular weight polyolefin; and
c) carbon footprint reducing material or materials;
d) filler, where component a) through c) account for up to 30% by weight, based on a total weight of the roofing shingle composition and component d) accounts for up to 70% by weight based on a total weight of the roofing shingle composition.

13. The filler of claim 12 comprises fillers suitable for roofing applications, such as those described herein, may be any inorganic fillers, ground reclaimed asphalt pavement (RAP), ground recycled asphalt shingle (RAS), or a combination of these, known now or in the future to persons of ordinary skill in the art, to be appropriate for inclusion in roofing products.

14. The inorganic fillers of claim 13 comprise mineral filler, fly ash, carbon black, or a combination of these. Mineral filler is typically ground stone or mineral, such as, for example, stone dust, limestone particles, and talc, among others. inorganic fillers, ground RAP, ground RAS is typically ground to a particle size of about 180 μm or less.

15. The roofing bitumen composition of claim 12 comprising 30-95% paving grade bitumen feedstock, based on a total weight of the roofing bitumen composition.

16. The roofing bitumen composition of claim 12, comprising about 30%-60% wt.bitumen recovered from recycled asphalt shingle (RAS), reclaimed asphalt pavement (RAP), and combinations thereof based on a total weight of the roofing bitumen composition.

17. The roofing bitumen composition of claim 12,
comprising about 5%-20% wt. recycled tire rubber (RTR), based on a total weight of the roofing bitumen composition.

18. The roofing bitumen composition of claim 12, comprising about 5% to about 30% wt. kraft lignin, based on a total weight of the roofing bitumen composition.

19. A method of making the roofing shingle composition of claim 12 comprising:
mixing the paving grade bitumen feedstock, the low MW polyolefin, and the carbon footprint reducing material selected from the group of kraft lignin, recycled fibrous material, recovered bitumen from recycled shingle (RAS) and/or reclaimed asphalt pavement (RAP), recycled tire rubber (RTR), and combinations thereof, at an elevated temperature to form a bitumen composition;
wherein a carbon footprint needed to produce the bitumen composition when compared to a carbon footprint needed to produce an oxidized bitumen from roof-grade bitumen is reduced by greater than 5%; and
a filler then is combined with the bitumen composition to form a roofing shingle composition.

20. The method of claim 19, wherein the bitumen composition is prepared by adding the carbon footprint reducing material and low MW polyolefin to molten base bitumen (e.g., NA PG 64-22 #1) at about 140° C. to about 200° C. A high or low shear mixer can be used to blend the mixture at about 200 to about 20,000 rpm and optionally at about 3000 RPM for 1 to 4 hours.
